(19) United States
(12) Patent Application Publication
(10) Pub. No.: US 2003/0234346 A1
(43) Pub. Date: Dec. 25, 2003

(54) Touch panel apparatus with optical detection for location

(76) Inventor: Chi-Lei Kao, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/064,203

(22) Filed: Jun. 21, 2002

(51) Int. Cl. G06M 7/00

(52) U.S. Cl. 250/221

(57) ABSTRACT

A touch panel apparatus with optical detection for location has at least one photographic fetching unit and a signal analysis unit. The photographic fetching unit is used to photograph a surface of the panel and a touching object on the panel, and then export a video signal. The analysis unit receives the video signal and analyzes it to obtain a location of the touching object on the panel. The panel can be a liquid crystal panel or a planar screen of a display or a projected plane by a projector.

### BACKGROUND OF INVENTION

1. Field of Invention

The present invention relates to a touch panel technology. More particularly, the present invention relates to a touch panel device with optical detection for location.

2. Description of Related Art

For the world in nowadays or in the future, the amount of information communication will be greatly increase, in which the electronic information is the main trend. Due to the great development on semiconductor fabrication, computer technology, and photoelectric technology, the information in an intellectual manner is more convenient for the public people to get the information or even can taking a control to execute some actions.

Touch panel is now a popular tool accepted by the public to serve as a interfacing tool for information communication. The design in application is to include a functional icon region. When the function icon is touched and then activated, the touch panel will display a page on the panel to provide the requested information etc. The user can directly choose the designed instructions on the touch panel through touching the function blocks or icons.

The feature for a touch panel mainly is to detect the touching point on the panel.

FIG. 1 is a drawing, schematically illustrating a conventional design for the touch panel. On a panel 100, a location detection device includes at least two photographic fetching units 106, which are connected to a signal analysis unit 90. The photographic fetching units 106 are located at the border 102 of the panel 100 and are distributed at the different positions for photographing the region to be detected. A light source 104 illuminates the panel from above. The photographic fetching units are used to photograph at least one plane over the panel, wherein the plane may be substantially parallel to the panel, and a touching object 108 on the panel. The optical signals are converted into electronic signals for exportation. The analysis unit 90 receives the video signal and analyzes out the location of the touching object on the plane through the two angles. The U.S. Pat. No. 6,100,538 has discloses the structure for the usual optical touch panel.

The conventional optical touch panel usually has a condition of limited detection height for photographing the panel. However, it very often causes a misjudgment due to the variation of the peripheral light source, light shade, photographing angle, a reflection of light at the border and into the photographing lens, and the light contrast between the touching object and the border under strong illumination. If the touching object is designed to have a light source by itself and to take the light intensity to be the only information for detection and judgment, then the border needs a rather large height for avoiding misjudgment.

### SUMMARY OF INVENTION

The invention provides a touch panel device with optical detection for the location, which can be operated associating with the natural light source in the environment, which can also use the light emitted by the LCD panel itself. Or, an artificial light source is used for illuminating the border, the panel, and the touching object when the environment is dark. The border is set with a predetermined color and a predetermined pattern, also and the touch object, such as a pen, is set with a predetermined color and a predetermined pattern. The border and the pen can also be designed to include a reflection portion and a light transparent portion associating with the optical design mechanism, so as to easily distinguish the touching object and locate its coordinate on the panel.

The invention also provides a photographic device, which photographs a planar panel by an angle. In order to reduce interference from the background light source, a line light source is included to form a light plane, which is close and substantially parallel to the planar panel, so as to illuminate a touching object over the panel and cause a reflection. In this manner, by photographing the reflection light of the touch object, the location is detected. This is a design, which may not need a border. The line light source can be a predetermined color pattern, such as alternating color such as R, G, B, or infrared, by a predetermined choice. This is helpful to detect the touching object.

The invention for another embodiment includes at least two photographic devices. At least one of the two photographic devices can photograph alone a detection plane, which is a plane parallel or substantially parallel to a panel plane of a panel. A light source has a distance from the panel plane by a height at a location, so as to illuminate the detection plane by a slant angle. The another one of the photographic devices in plane type to photograph a touching object by a slant angle, so as to detect its position. The detection plane illuminated by the light source can include a visible pattern, an operation area, a touch panel, or a keyboard. The light source can include alternating color lights, such as R, G, B, or infrared, by a predetermined choice. The touching object can further includes a light emitting source, which can be activated through a touch button, so as to emit a predetermined color pattern, such as alternating color lights, such as R, G, B, or infrared.

The invention provides at lest a photographic device, with a photographing plane by a slant angle, to photograph a touching object such as a pen, which can move on another planar movable being touched object, such as a paper with a direction. As a result, positions of the pen on the paper are detected, whereby a relative motion of the pen on the paper. The paper is directional and the direction can be detected and exported.

The present invention provides a method for an application of the photographic photosensing device by a color manner. The border is set with a color pattern. The touching object is also set with a color pattern, such as color finger or color pen. Then, the location of the touching object, such as at least one pen or the finger, is detected out even if the at least one pen and the finger do coexist on the panel. The location of the pen with at leas one specific color pattern can be detected even without the border. For the color sensor, since a color detection point needs three primary colors for detection, the color photosensing device usually includes three colors and causing a decrease of sensibility. However, the detection sensibility can be enhanced by including another sensing array by a single color, or arranging the three colors in three parallel sensing lines.

The present invention provides a method for design a border for an optical location detecting device by a principle of color strip pattern, wherein it also can includes a light transparent structure and a light reflection structure. Therefore, the brightness of the border is enhanced and the misjudgment due to the light noise is reduced.

The present invention uses the environmental light source or implementing with a light source to illuminate the touching object, so as to detect the predetermined color pattern of the touching object and analyze the location. The touch object can be designed to have a light reflection portion or have a light transparent portion, so as to increase the brightness of the touching object, and to prevent misjudgment due to the light noise from occurring.

According to the image analysis results for the touch object, a region of image can be neglected to treat it as a background image. A shadow region of hand, which blocks the touching object, can also removed. At least one photographic device is chosen to optically detect the action of touching. The following method can be used to analyze and judge. A touching pen is set with a setting pattern, wherein the touching pen has a size. The finger of the touching object also has a reasonable size. The finger can have a color resulting from a learning for memorizing the color before actually using it or a setting color input by the user. At least one photographic device is implemented on the panel, so as to detect the light signals emitted from the touching object on the panel. The pen with a light signal can flash a light with a specific frequency when a touch occurs at the tip of the touching object. All of the above parameters are used in the analyzing method in combination.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a drawing, schematically illustrating a conventional design for the touch panel;

FIG. 2 is a drawing, schematically illustrating an optical touch panel, according to one preferred embodiment of this invention;

FIGS. 3A-3D are drawings, schematically illustrating the pattern of the border, according to one preferred embodiment of this invention;

FIGS. 4A-4B are drawings, schematically illustrating the consideration and the results when an external strong light source illuminating on the border, according to one preferred embodiment of this invention;

FIGS. 5A-5B are drawings, schematically illustrating the photosensing array in black and white cells, according to one preferred embodiment of this invention;

FIG. 6 is a drawing, schematically an optical touch panel with position detection using the visible light as the source, according to one preferred embodiment of this invention;

FIGS. 7A-7C are drawings, schematically illustrating the color photosensing array, according to one preferred embodiment of this invention; and

FIGS. 8A-8B are drawings, schematically illustrating another design of the border, according to one preferred embodiment of this invention;

FIG. 9 is a drawing, schematically illustrating a structure of the touching panel, according to one preferred embodiment of this invention;

FIGS. 10A-10B are a drawing, schematically illustrating a detection mechanism for measure the X and Y coordinates, according to one preferred embodiment of this invention; and

FIG. 11 is a drawing, schematically illustrating a judging mechanism when the touching object is approaching the panel, according to one preferred embodiment of this invention.

### DETAILED DESCRIPTION

Embodiment 1

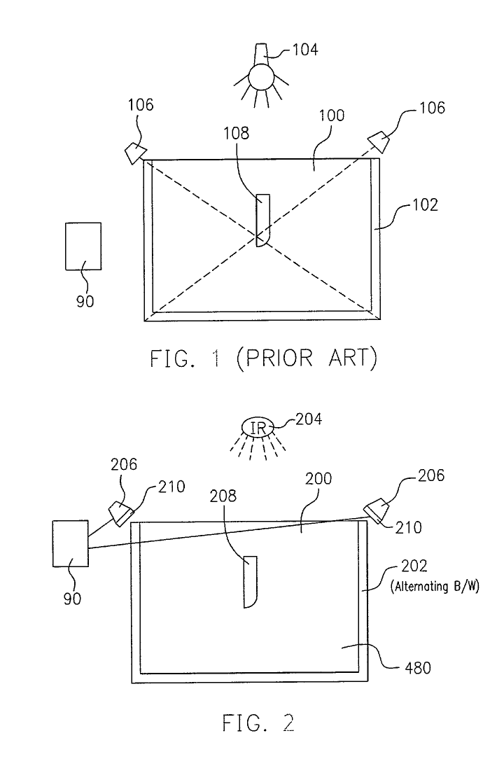

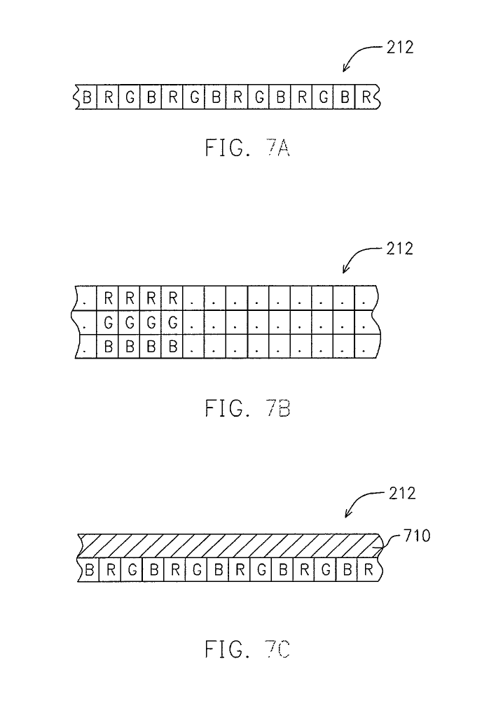

The present invention has the features about photographing the image and performing the analysis, so as to detect and determine the coordinate of the touching point on the panel. FIG. 2 is a drawing, schematically illustrating an optical touch panel, according to one preferred embodiment of this invention. The touch panel includes a panel 200. A border 202 can be included and is disposed at the periphery of the panel 200. The panel 200 can include, for example, a liquid crystal panel. The photographic device 206 is located at a corner of the panel 200. The photographic device 206 includes a line or multiple lines of photosensing cell array as shown in FIGS. 7A-7C, or such as a 640×4 array. The photographic device 206, for example, has a wide range of 90 degrees to photograph all the range of the touch panel. Another photographic device 206 is located at the other cornet, so as to form at leas one detection plane. When the touching object 208 reaches to the panel and cross the detection plane, it is treated as a touching point. The two photographic devices 206 detect the touching object 208 in the crossing angles, so that the touching point can be calculated out according to the two angles.

The present invention introduces a touch panel device, which can be operated under a fluorescent light in the inner room or using the light emitted from the panel of LCD to illuminate the border and the touch panel. It can also include an artificial light source with the range of visible light to illuminate the border and the panel.

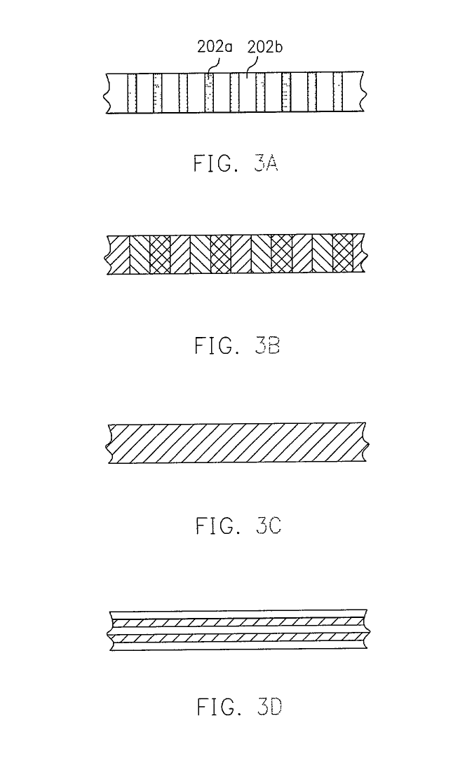

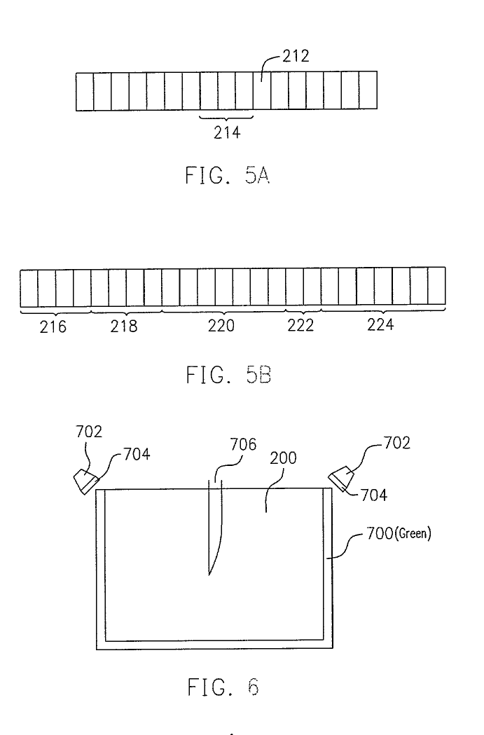

FIG. 6 is a drawing, schematically an optical touch panel with position detection using the visible light as the source, according to one preferred embodiment of this invention. Also and, as shown in FIGS. 3A-3D as examples, FIG. 3A shows the border 700 designed by a number of strips with different shade degree and alternatively arranged together. For example, it can be the black strips and white strips alternatively arranged or dark green and light green strips alternatively arranged. In FIG. 3B as an example, the color strips can also be used. In FIG. 3C as an example, a setting single color for the border which is different in color from the touching object or finger. In FIG. 3D as an example, the border 700 can also be designed to have the strips in horizontal parallel pattern, wherein the strips can also be the alternating black, white or color. The pattern of the touching object can also be designed with the pattern in FIGS. 3A-3D.

The selection principle for the touching object 706 under the background of the border 700 is to easily distinguish the touching object 706. For example, it can be chosen that a blue border associates with a green pen and a yellow finger. In this arrangement, a color natural light reflected from the touching object has a color contrast, so as to judge the finger, pen, or border. The RGB color can be used detected according to their intensity. For example, the blue border is detected by a color index of R=1, G=1, B=15. A green pen has an intensity of R=2, G=15, B=2. The yellow finger has intensity of R=8, G=8, B=1. Therefore, the location of the at least one pen or finger can be analyzed out. If the at least one touching pen and the finger do coexist, the position of the at least one touching pen with a setting color can be detected. The Since the color of finger may change for different people, the colors of border and touching pen can be properly set for distinction, in which the finger can block the blue border and the color of the finger is different from the colors of the pen and the border. The color of the finger can be an assigned color or a color based on a learning practice before actually using it. The color of the touching pen can also be an assigned input data. For example, when the pen is detected as a color, then the line written by the pen on the panel is shown by the same color.

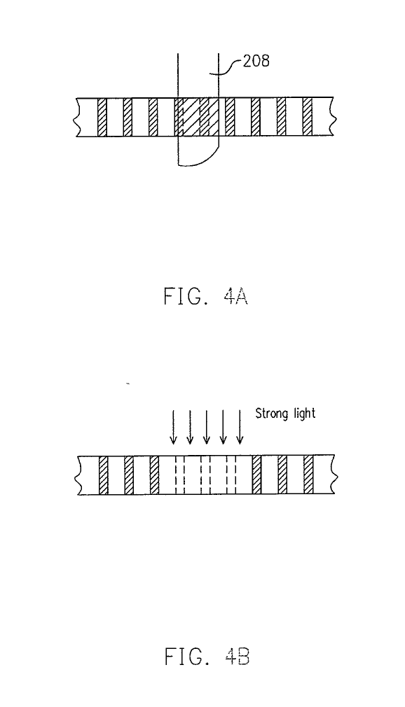

The border can also be a strip pattern design. The analysis unit can record the pattern information of the border about the strip pattern. For example in FIGS. 4A-4B a dense strips alternatively arranged in black and white to have the contrast. The width of the dense strips is at the level that the touching object 208 can block the strips. The analysis unit 90 can find out where is the missing region of the strips based on the pattern information, wherein the location of missing strips is the location of the touching object 208 at the related border. The analysis unit 90 can compare the current photographed information with the previous photographed information being stored. If the missing part of the strips is not always occurring at the same place, it can be judged that the effect is resulting from the shielding of the touch object 208. This manner can avoid the noise from a dust on the lens, for example. For a case that a region of the border is illuminated by a strong light, this method can still recognize the black-white strips. The strips can also be color.

The dense strip pattern set on the border as shown in FIGS. 3A-3B can also be used as a coordinate reference in detection, or can be used as a correction pattern for the shooting angle of the photographic device or sensitivity correction on the angle error due to lens distortion. It can also be used to automatically correct the lens in optical bias, so that an error of the shooting angle taken by the photographic devices, which induce the x, y location errors, can be corrected. Or even a height error of the detecting plane, which is a Z error resulting in not able to detect the dense strips, in which case one of the multiple detecting planes formed by multiple sensing lines can be chosen, can be corrected. Also and, it can be used as a correction pattern of the detection location. It even can be used to correct the detection position while assembling the photographic device on the border.

If the side of the panel has a strong light source or lamp, the light after reflection by the border could enter the photographic device or the lights directly enter the photographic device. In this situation, since the incoming light intensity is too strong, the color or pattern on the border and on the pen cannot be detected. In another situation as shown in FIG. 4B, the pattern on a portion of one side of the border cannot be detected due to the strong light source or direct light into the photographic device. The portion having strong light typically is a bright region.

In order to solve the phenomenon on over-bright region or any external interference, the invention introduces several solution.

FIGS. 5A-5B are drawings, schematically illustrating the photosensing array in black and white cells, according to one preferred embodiment of this invention. The photosensing cells 212 correspond to a detection point. With respect to the region with strong light intensity in FIG. 4B, the photosensing cell array has a saturation region 214. In the invention, the analysis unit 90 can control the optical gain for the photosensing cells, so as to make an adjustment. If the there are several strong light regions as shown in FIG. 5B, the array can be divide into several regions 216-224, and the regions can have different gains. This kind of gain adjustment can be applied to a color photosensing cells and infrared photosensing cell.

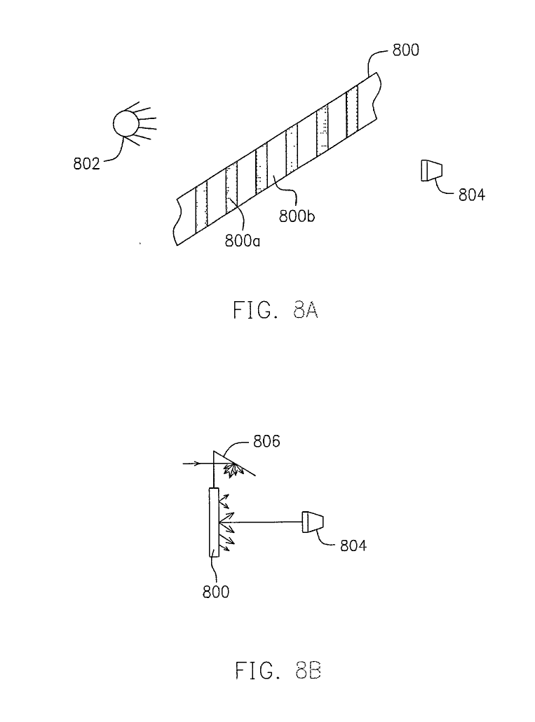

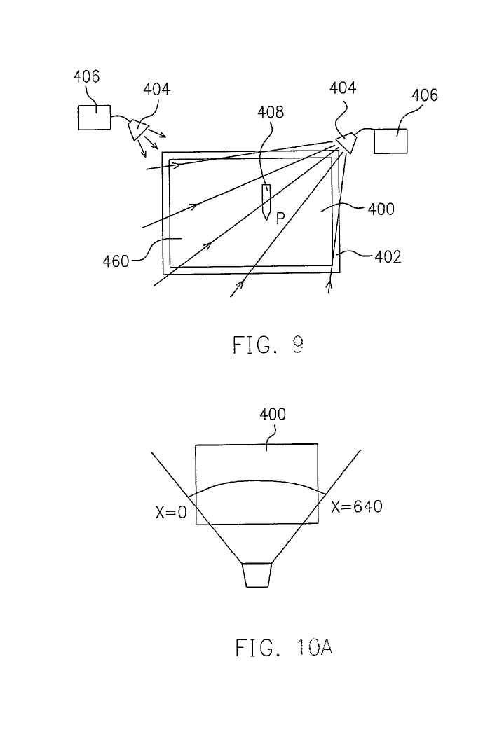

Another method and design principle are shown in FIGS. 8A-8B. When the photographic device 804 photographs the pen, the color of the pen could be not able to be distinguished due to the light source 802 with too strong light intensity. For example, if a pen is disposed in front a lamp of 100W, the camera cannot shoot the color of the pen due to the over strong light intensity. However, the pen can be designed with, for example, a setting green-light transparent pen. When the strong light source 802 illuminates the pen, the light can transit the pen to enhance the brightness of the green color. When the light intensity of the lap 802 is stronger, the brightness of green light on the pen is accordingly stronger, so that the interference of the background light incoming into the lens can be effectively reduced. This is called the light enhance mechanism. Further in another method, the pen can also include a light reflection region, so that the light of the environment can be reflected onto the pen so as to increase the brightness of the green pen. Here, this mechanism is called as the reflection-type light enhancing mechanism. The pen can emit a flashing light with a specific frequency, and the pen can have the setting pattern. In this manner, the panel may need not the border or just a small height border and it has been sufficient to detect the movement of the touching pen. The pen can include a light emitting source activated by a touching switch. When the touching switch is touched to activate the light emitting source, it is considered as a touch on the panel. Or, when the image of the pen is sufficiently close to the panel, it can be considered as a touch. The pen can be detected by a light emitted by the pen itself and may have a specific frequency, and the pen can also have the pattern as shown in FIGS. 3A-3D for discerning the pen. After analysis, the touching point of the pen is obtained.

Moreover as shown in FIGS. 8A-8B, using the as principle for designing the pen, the border 800 can be designed to include an opaque region 800a and a transparent region 800b, in which the transparent region 800b can be a color transparent region. Consequently, when the border 800 is under the strong light source 802, the color transparent region 800b can still be clearly distinguished. Furthermore in FIG. 8B, the outer side of the border 800 has the reflection region 806, the background light of the border 800 entering to the reflection region 806 can be reflected onto the border 800. When the background light 802 is stronger then the pattern of the border is brighter. Also and, the reflection region 806 can reflect the light emitted from LCD panel by itself, which is below the border, onto the border to enhance the brightness of the pattern. The light emitted from LCD by itself can also directly illuminate the reflection region 806, causing the pattern on the border to be reflected. As a result, the brightness of the border is increased, and the affection from the environment is reduced. It is called reflection-type light enhance mechanism.

In the foregoing case, black and white can have better contrast, in which the white portion can reflect white color for the original designed part. The transparent material can also improve the brightness under the background light environment. The black part is expected to be not transparent for the light. In this manner, the black-white contrast can be improved. This called the transparent-type light enhancing mechanism. The above description is just an example, the combination of color and the transparent or non-transparent design are not beyond the scope of the invention. The other optical designs with the effects are also falling into the scope of the invention. For example, the color combination can be blue/black, green/white, red/white, blue/red dark green/light green. The border in single color can also be designed to include a light transparent portion and non-transparent portion in combination or a complete transparent design. The degree of color shading in the same color can also be used. The purpose of the light transparent design and the reflection design is to improve the color brightness of the border, so as to improve the contrast to have clear strip pattern.

In the foregoing design, the light source can be modified into an infrared light source to illuminate the border. In this manner, the photographic device can be an infrared the photosensing device, and the border is preferably designed with black/white pattern. The shooting angle of the photographic device can be a planar photographic device 206 with a shooting plane composed of, for example, 640*480 point of CMOS sensors. The shooting angle can be a slant angle to detect the touch panel. The border 700 can be a table, which is used to hold the touching panel of the invention, with a color different from the touching pen and finger. The details can further be referred to the following embodiment 3 and embodiment 5.

Embodiment 2

The invention also introduces a design of the photosensing device in operation. The photosensing device can include one line or use multiple lines of photosensing cell array to improve the precision. In FIG. 7A, the photosensing cell array can be composed of color photosensing cells of R, G, and B in alternating order. In another design as shown in FIG. 7C, it includes two parallel lines of CMOS sensors, such as 633*2 points. One line of the sensors can be implemented by the R, G, and B cells in alternative arrangement by 633 points. It can also include a design to filter the invisible light source. The other line 710 of the sensors can be implemented by a single color sensor, which filters a portion of the visible light, such as one of the R, G, and B colors, by 633 points, or an or infrared CMOS sensor to filter the visible red light. The alternating R, G, B in 633/3 points is used to detect a rough location of the touching object, so as to further avoid the misjudgment. The sensing array 710 in a single color of R, G, or B by 633 point is used to precisely detect the location with respect to the rough location of the touching object. The color of R, G, and B for the border can also be detected. The detecting precision can be improved. Moreover, the pen can be also designed to emit the red light. One infrared sensing array to detect the location or a red single color sensing array is further included to roughly detect the location of the color finger. The color of the single color sensing array can also be set the have the same color of the border or pen to have the same purpose. Another yet method is to design the sensing device with several parallel lines of CMOS sensors, each of which has different color. The line includes, for example, 633*3 points. For example, one line of R, one line of G, and one line of B are included to improve the precision as shown in FIG. 7B. Another yet method is to design the sensing device with several parallel lines of CMOS sensors, each of which has FIG. 7A sensing array. And at each line the color of the sensors is shifted one sensing cell compared to the next close line, so the detect resolution is increased to improve the precision.

Embodiment 3:

Optical Position Detecting Apparatus with a Photographic Device Shooting in a Slant Angle.

In FIG. 11, at least one photographic device 404 shoots the panel 400 by a slant angle. Optionally, a light source 430, such as a visible light or infrared light, is included. The light source 400 can be disposed close to the panel 400 and is a line-type light source, so as to for a light plane over and close to the panel in parallel or substantially parallel to the surface of the panel. Optionally, a light source 431 is also included to illuminate the panel. Also, a projected indication mark is used to define a touch region for the user.

The optical position detecting apparatus of the invention makes use a manner of taking image and image, so as to detect the coordinate of the touching point on the touching panel. The photographic device 404 shoots the touch panel 400. The photographic device 404 in a slant view takes the panel 400 as a background image. Further, the panel can provide the border information. In order to prevent the strong light from entering to the lens, the panel is selected to have the surface with reduced reflection effect, so that the light noise from the environment can be solved.

FIG. 9 is a drawing, schematically illustrating a structure of the touching panel, according to one preferred embodiment of this invention. The touch panel includes a panel 400. The panel 400 includes, for example, a LCD panel or a projected region of a table by a projector. The projected region can be, for example, a tetragon, a square or a rectangle to serve as touching operation region of the touching panel. The projected region can also be defined by the projected indication mark relative to the position of the displaying screen. The projected region can also be a setting region on the table relative to the optical position detecting apparatus. In this manner, a virtual touching panel is set up for operation through a touch, and then to control the motion of the cursor on the display screen. At least one planar photographic device 404 is implemented at a peripheral place of the panel 400, so as to shoot the whole touching panel 400 from an angle, such as 15 degrees, in a detection plane 460. The photographic device has a resolution of, for example, 640*480 points. The planar photographic device 404 is coupled to the analysis unit 406. The analysis unit 406 can also be built in the photographic device 404 to have an integrated unit. When the touching object 408, such as a pen or a finger, touch the panel 400, the planar photographic device 404 shoots the panel 400 and the touching object 408. The analysis unit 406 analyzes and distinguishes the touching object 408, so as to obtain the touching point P on the detection plane 480 over the panel 400.

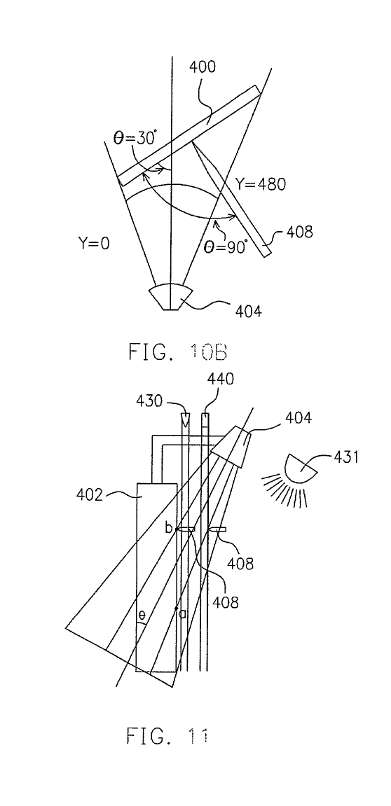

FIGS. 10A-10B are a drawing, schematically illustrating a detection mechanism for measure the X and Y coordinates, according to one preferred embodiment of this invention. In FIG. 10A, for example, the photographic device 404 is located at a corner and shoots the panel 400. The view angle distribution on the x coordinate is defined.

The range of X can be, for example, 0-640. Likewise in FIG. 10B, the y coordinate is defined with a range of, for example, 0-480. The drawing the cross-sectional view along the y-plane.

For example, the touching object 408 is detected being located at x=320, y=470, then the location is at the upper central region of the panel 400. If the location is at x=320, y=220, then the touching object 408 is located at the lower central region. If the location is at x=310, y=120, then the touching object 408 is located at the right central region. In this manner, a single planar photographic device 408 can detect two directions to judge the touching location.

The touching object 408 can also include a columnar object with a sharp tip toward to a direction, such as a square columnar object with a sharp tip, like a pen or a hand with a finger. When the pen is used, the pen preferably has an angle with respect to the photographic device 404, as shown in FIG. 10B. The angle to the panel 400 in the case of FIG. 10B is necessary to be greater than 30 degrees, and preferably is 90 degrees. Also in FIG. 11, as the touching object 408 is photographed by the photographic device 404, due to the photographing ting angle, the tip of the touching object 408 is the closest point to the photographic device 404. The explanation is provided later.

The touching object 408 can have an input assigned color information, which is different from the color information of the panel 400, also have a detection information for the touching object 408 of finger or pen. The detection information includes a reasonable size and the panel 400 with different color shape pattern. The detection can also be a setting result for size, color, shape of pen or finger, resulting from a learning stage before the detecting apparatus is actually operated. The information about the shape pattern of the pen with the tip and the color information are used to analyze and look for the touching object 408. The panel 400 can also be photographed and input as a background information, used in the analysis.

In addition, since the touch panel of the invention is photographed by the photographic device 404 by a slant angle, the touching object 408 has been photographed by the photographic device 404 before actually touching the panel 400. This may cause a miss-judgement on touch. The touching point then can be determined by the following methods.

One is that when the touching object 408 stops on the panel 400 for a period of time at the touching point b, the touching point b then can be judged as the touching position desired by the user. However, if the touching object 408 is approaching to the panel, the touching object 408 does not stay at one place for the sufficient period of time. In this situation, when the touching object 408 does not actually touch the panel 400, the image of the touching object 408 will be seen in motion. The in the whole motion, the desired touching point b can be determined to be the point which is the least point to the photographic device 404. This method to determine the touching point is called the analysis method by the least point in motion.

In FIG. 10B and FIG. 11, the photographic device 404 is arranged with a slant angle θ from the panel 400. The angle θ has a range possibly up to 45 degrees, in which the range of 3-30 degrees is preferred. Since the photographing effect is a two-dimensional effect, the photographing plane 900 is the viewed planar image by the photographic device 404. When the touching object 408 approaches to the panel from outside, the tip of the touching object 408 is seen by the photographic device 404. It cause a viewed touching point a on the panel 400. When the touching object 408 indeed touch on the panel 400, it has another viewed touching point b on he panel 400. The touching point a is rather far from the photographic device 404. The touching pint b is the closest one to the photographic device 404. When the touching object 408 stay on the panel with sufficient period of time, and leaves. At this time, the touching object 408 is moving outward. The tip of the touching object 408 seen by the photographic device 404 is again shifting to the touching point a. Therefore, in this motion, the closest point of the touching object 408 viewed by the photographic device 404 is the actual touching point, that is, the touching point b. This method is also referred as the analysis method by the least point in motion.

For another example, it can be applied to a light-emitting pen, of which the touching object 408 has the touching switch. A light is emitted after the touching switch is turn on by touch. The light is emitted from a light-emitting region at the tip, which can also be a protruding structure. At least one planar photographic device 404 can detect the light signal, so that one of the detected light spots from the light-emitting region at the least point to the photographic device 404 is used as a reference to determine the actual touching point. This is because the actual touching point and the closest detected point have a relative distance due to the two points being not exactly matched in space. The pen may have the actual tip to touch the panel, then the light-emitting region is sufficiently close to the actual tip of the pen or having a relative distance as a reference. The pen light emitting region may be large, so one point of the region will select as the touch reference point, since the point close to the tip of the pen, the position detect error will be smallest, otherwise the angle change in use will affect the position detect. Thus, the point, which is closest to the tip of the pen, is the best choice. Also and in video information since the pen have a limit for the angle being used, this best point will be closest to the photographic device, it is called the principle of the closest point detection. It should be noted that the closest point detection is different from the forgoing descriptions about the principle of the least point in motion. The least point in motion is about the detection of touching point when the touching object is moving toward to the touching panel. However, the closest point detection is related to the closest point within the tip region being detected.

When the pen is used, it preferably has a limitation for the operation angle. When the light emitting region of the pen and the photographic device 404 is very close, the image of the light emitting region will be enlarged due to the distance to the photographic device 404 being close, or the pen light emitting region is large, so many sensing cells would detect the set light emitting region. In this situation, the foregoing method of detecting the closest coordinate could be failed, in which one point of the light emitting region of the pen at the farthest place could be considered as the touching point. This is a severe position error, because this point is far away to the actual tip of the pen.

Another example is further introduced, by including at least two planar photographic device 404, as shown in FIG. 9. The method of detecting the closest coordinate is still can be employed. The two photographic devices 404 separately detect the least coordinates, so as to analyze out the position of the tip for the touching point in 3-dimentional manner. In this manner, the pen or the finger has at least one protruding tip to touch the panel 400. Further, a pen held by a hand, a pen's tip or the finger have a different color from the color pattern of the panel 400. Alternatively, the touching object 408 for the pen or the pen tip can have a set color pattern for detection. Or, the touching object 408 as a pen can have a light emitting region on a protruding tip. Whereby, the touching object 408 under the detection condition can be detected as a motion object.

The analysis unit 406 can discern and analyze a portion of the touching object 408. By the method of least coordinate without too complicate image discerning algorithm, the 3-dimensional position of the tip can be detected, and the motion of the touching point on the panel can also be detected. Thus, the touching object has tip with a color different from the color of the panel 400. The touching point or the motion in touch on the panel can be detected by analysis using a background image color pattern, which is taken by the photographic device on the panel 400. The background image color pattern of the panel 400 can be stored for comparison. Since the operation angle is restricted, the closest point of the pen tip to the photographic device 404 in different color from the background color can be analyzed to known the movement on the panel 400. In the analyzing method, the least point is used as a reference point to the actual touching point. This is because the detected point may have a little distance to the actual touching point. In addition, the detection information with respect to the touching object about a reasonable size and range can be optionally input, so as to discern the background object or the touching object. When the pen is held by a hand in operation, it has a restricted operation angle with respect to the photographic device 404. If the pen held by the hand has a direction is not toward to the photographic device 404 but in backward direction instead, and if the detection information is used to look for the region with the different color from the panel, then the apparatus may misjudge a region of the hand as a tip of the touching object, then an error result of the position occurs.

In FIG. 11, another method is introduced by implementing at least one linear photographic device 440 at a place of the apparatus in addition to the planar photographic device 404. The linear photographic device can photograph a plane, which is over the panel and is substantially parallel to the surface of the panel, and at least one touching object, so as to determine the location of the at least one touching object 408. When both the planar photographic device 404 and the linear photographic device 440 can detect the touching object 408, then it is the touching point b.

In addition, the light source 430 can be chosen, for example, to have a specific wavelength or an alternating color lights varying in R, G, B, infrared light, or a light with specific flashing frequency. The light source 430 can be implemented close to the panel 400 to form an illumination light plane, which is substantially parallel to the panel 400. In this manner, when the touching object 408 of the pen or the finger touch to the panel 400, the light plane will be illuminated by the light source 430. Then the photographic device 404 can detect the reflected light of the light source 430 from the touching object 408. This is different from the embodiment 1. The design of the border then may be omitted. Thus, the photographic device 404 takes the touching panel 400 as a background image, to equivalent serve as a border. The photographic device 404 can have a sensing cells of R, G, B or an infrared sensing cells for detection, so as to determine the position of the touching point. The light source 430 alternatively emits the lights with different wavelength. The photographic device performs the detection according to the specific light pattern in wavelength. For example, the photographic device 400 takes the image of the panel 400 as a background information. The light source 430 then emits a read light. The panel 400 would not reflect the red light of the light source 430. As the photographic device uses the red sensing cells for detection, it is judged whether an additional red reflection region appear due to the reflection by the touching object 408 after comparing with the background image. With the same way, the different light of R, G, B, or infrared can be emitted in alternating, so as to suit for different color for the panel 400.

The detection algorithm is as follows: A least one touching object 408 is placed over a panel 400 without actual touch. At this moment, it is not illuminated by the light source 430 yet. The photographic device 400 cannot detect reflection light, then it is not in touch.

A least one touching object 408 is placed over a panel 400 at a place outside of the detection plane 480 but is illuminated by the light source 430. Since the photographic device 404 does not detected the reflection light, and then it is judged as a situation without touch.

At least a one touching object 408 is placed within the detection plane and is illuminated by the light source 430, then the photographic device 404 can detected the reflection light from the light source 430, the a touch occurs. The planar photographic device 404 with two-directional detection for the location. Or two photographic devices in two shooing angles are used to detect the location.

In addition, a light source 431 can also be included. The light source 431 is a visible light source to project an image pattern onto the detection plane. The light source 431 is to produce a visible mark projected on the panel to define touching region for the user. For example, it can be a keyboard, or rectangular touching region to serve as a touch panel. The light source 431 and the light source 430 to produce a light plane substantially parallel to the panel can be in alternating operation, so as to prevent avoid the interference to the reflection light from the light source 431. The light source 431 can also be an detection light source as will be describe in embodiment 5.

In addition, one method is using a pen as a touching object 408, having a tip with a setting detection color pattern that is different from the panel and the finger. At least two photographic device's 404 are used for detection. Also and, a 3D detection for the tip position can also be performed to judge whether or not the tip has touched on the panel 400, so that the touching position of the touching object 408 on the panel 400 can be detected.

In the foregoing design, the touching object 408 can be a light emitting pen. When it is moving, a light signal can be emitted from the pen tip, wherein the light signal can be emitted by a touch. The light can have a light pattern in alternatively emitting R, G, B colors. It can also have a specific frequency. At least one photographic device 404 is used to detect the position. In this manner, the resolution will not be reduced while using the sensing cells of R, G, and B. This is because the position of the touching object 408 can be detected out by the sensing cell in one color. This method is suitable for use under the illuminating source or the light emitting touching object in this embodiment. In FIG. 7A about the sensing cell array, a photographic unit has R, G, B cells arranged in sequence. The light emitting pen alternatively emits the R, G, and B lights. The position of the pen can be detected by the sensing cells. If the pen only emits the red light, then the G and B sensing cells cannot detect the position.

However, in the invention, a position detection by most sensibility is proposed to detect the position of the pen, which can alternatively emit the R, G, and B light. After the pen has emitted the R, G, B light, the analysis unit then analyze the position of the pen. In FIG. 7A, the sensing cells can include the R, G, B sensing cells, so that it is possible to detect the tip of the pen, which emits the R, G, B light at the same position. The sensibility for detecting the position is not reduced. The position can be based on the most left cell and the most right cell, which are capable of detecting the light emitted by the pen. It will not occur that the position of the pen cannot be detected due to different color. The position can be one of the cell position in the range between the most left cell and the most right cell. For example, according to the light intensity distribution, the position corresponding to the most probable intensity is analyzed out or simply just takes the middle point. In this manner, when the pen is shifted by one sensing cell in position, the photographic device in FIG. 7A can still detect the shift by one cell according to the light signal emitted from the pen with respect to the sensing cell array. Then, the most left cell and the most right cell. This mechanism with R, G, B emitting light is called, in the invention, the position detection analysis method with the most sensibility position

The touching object 408 can be designed with a setting color pattern. The touching object 408 can also include a setting pattern structure following a light enhance mechanism, so as to reduce the light noise in detection.

Embodiment 4:

Design for a Planar Touching Member a Detection of a Pen Writing on the Planar Touching Member

The design in the foregoing at least a planar photographic device 404 can be applied to a touching object 408 of a pen, which is writing on another planar touching member, such as a paper, about the touching position. In FIG. 11, the planar touching member can be included and is movable, such as a color paper, a white paper, or a paper with a direction mark pattern, or even the paper itself is directional. The planar touching member is disposed one the panel (see FIG. 9). The panel can be a table with a different color. The planar photographic device 404 has sensing cell array of 640*480 in color, black/white, or infrared. The photographic device 404 photographs in a slant angle or a right angle to have a detection plane. A light source 431 can also be included to illuminate the planar touching member, and can be a infrared or a visible light. The planar photographic device 404 can photograph the writable planar touching member on the detection plane, according to the input detection information about shape, size, brightness, color, pattern, so as to determine the writable planar touching member, such as a white paper, a notebook, a rectangular member. The writable planar touching member can have the size, shape, color, or pattern, which is input for use in distinguishing. It can also be the information of the planar touching member resulting from a learning stage.

The analysis can be performed as follows. For example, the input information for a rectangular shape for the planar touching member, so as to detect the touching object 408. The rectangular member can be discerned to satisfy the information of the movable planar touching member. After analysis, the shape, the color, and the location over the detection plane can be known. The left-upper corner is located at x=100, y=200, and the right-upper corner is at x=300, y=200, an the color is white, and width=10 cm, length=20 cm.

For example, a white planar touching member has a setting information, so as to detect a planar touching member which is satisfying the setting information. After analysis, the size and location are obtained. For example, a output signal satisfying the information of white rectangular member with left-upper corner being located at x=100, y=200, and the right-upper corner being at x=300, y=200, and width=10 cm, length=20 cm. This white rectangular member is disposed on a table. It direction is aligned to photographic device by an angle not greater than 40 degrees. It is movable and it allows a pen to touch on it in writing. Usually, when the user puts a circular paper or a paper without direction, it does not work.

The planar movable writable touching member can be designed to have a directional mark for discerning. For example, a dark mark can be assigned on the upper-left corner of a circular paper. As a result, a direction is defined on the circular paper, then the circular paper can be used for writing. The movement of the touching pen 408 on the planar touching member can be detected.

The information for detecting the planar touching member can include a rectangular region with direction and has different color from the environment. Once the color rectangular paper is disposed on panels with different color, the detection action then looks for the region having the different color from the environment color and having the shape with direction. Optionally, the rough size can be assigned also. Once the color, the location, and the direction of the paper have been detected out, then a touching pen can write on the paper by detecting the position of the touching point of the pen. When the paper is shifted, the current location of the paper can also be detected. Then the relative position between the touching pen and the paper can be detected. The information is converted as an information signal for output.

One function is that it can detect a size and direction of the planar touching member, which is a writeable paper, such as a personal information card or business card with the size and direction. This information can be output and used for discerning the information card.

Another function is to detect a touching movement for the touching object on the movable planar touching member. A coordinate signal with respect to the planar touching member is exported, and the planar touching member has the function like a keyboard function.

Embodiment 5:

A Method for Detecting the Position for a Light Emitting Region with a Light Source by a Slant Illumination.

As shown in FIG. 2, an optical position detecting apparatus is disposed on a detection plane 200. At least two photographic device 206 with 640*4 or 640*1 detection points are used to photograph and detect a plane, which is parallel or substantially parallel to the detection plane 200. A light source 204 illuminates the plane 200 from a slant angle, so as to project a rectangular keyboard image pattern with different depth of color shadow, a rectangular/square touching panel image pattern, or a rectangular/square region under an infrared source, so as to form a detection region. A border 202 may be used to define the detection region. The light source 204 projects a rectangular/square detection region and the touching object 208. The detection region over the plane 200 is a detection plane 480. The light source 204 can also be a visible light source 204 to project an indication for defining the operation region. The photographic device 206 detects the reflection light of the light source 204 from the touching object 208, whereby the touching point can be analyzed out.

A few of situations are described as follows: At least one touching object 208 is located over the detection plane 480 without touching yet. Even though the touching object 208 is illuminated by the light source 204, the photographic device 206 does not detect the reflection light of the light source 204. It is concluded to be not touching yet.

At least one touching object 208 is located outside of the detection plane 480, then is not illuminated by the light source 204. the photographic device 206 does not detect the reflection light of the light source 204. It is concluded to be not touching yet.

At least one touching object 208 is located on the detection plane 480 and is illuminated by the light source 204. The two photographic devices 206 have detected the reflection light of the light source 204. A touch then occurs. Then, the two photographic devices 206 detect the position of the touching point by two detection angles.

According to the embodiment 3 and embodiment 5, the same principle is following:

It includes a photographic device, a touching panel with a variable color, a touching object, and a light source emitting alternating different colors of R, G, B, or a single color light. The light source and the photographic device have an angle relative to each other, in which the photographic device cannot directly detect the light source and a reflection background light from the touching panel. The photographic device detect the reflected light of the light source in different alternating colors of R, G, B when the touching object touches the touch panel and causes the reflection. The touching position can be analyzed using the reflected light of the light source. The background image information can be photographed before actual operation and stored for analysis in comparison.

Embodiment 6:

Design for a Virtual Touching Panel and Virtual Keyboard

Using the planar touching member in embodiment 3 and the optical detecting apparatus of embodiment 4, the invention also provides a design for a virtual touching panel and virtual keyboard in the optical position detecting apparatus. An optical position detecting apparatus can be freely moved on a plane, such as a table plane. A display screen is to display an image pattern to indicate the location of the operated touching point, such as a movement of a cursor. A touching object is used by a user to perform a touching operation. A photographic device is used to detect a detection region over the table plane. Optionally, the plane can be disposed with a projection device, a paper or book, an object with direction, or a paper with keyboard pattern.

As to the virtual touching panel and virtual keyboard, it can be as follows:

1. It can be a virtual touching panel with an operation region, created by a projection within the detection region on the table plane by a tetragon shape, such as a rectangular shape or a square shape.

2. It can be at least two marks projected on the table plane within the detection region. The at least two marks define an operation region with a direction. For example, four protected marks are four corners of a tetragon region to define a virtual touching panel. Also for example, two upper corners of a projected rectangular/square region are equal to the upper two corners of a virtual touching panel.

3. It can be a setting region over the detection region relative to the optical position apparatus. For example, it is located a place having a distance to the apparatus by a 5 cm along a direction, and the size is 0*10 cm². This region can be described to the user in the user's handbook.

4. It can be a movable object with a direction. For example, an operation region of the touching panel is set on a movable rectangular/square paper.

5. It can be a region over the detection region defined a movable and directional object. For example, a region of 10 cm*10 cm relative from a long bar object along a direction.

6. It can be a paper printed with a keyboard pattern along a direction, disposed over the detection plane of the optical position detecting apparatus of the invention.

In the foregoing 4-6 items, the purpose are to provide information of the object, so as to discern and analyze out the location, the size, and the direction. In this manner, a virtual touching panel can be defined. The user can use a touching object, which can be detected by the invention, to operate like a solid actual touch panel. In addition, once a desired object has been detected, then the location of the touch panel is automatically adjusted to fit the object.

Embodiment 7

Another application of the invention is directed to use of a mouse. The touching object can be mouse, which has an indication structure with a recognizable setting pattern. The setting pattern can include, for example, an active light emitting mechanism or a color setting pattern, as previously described. Since the mouse usually is operated on a plane of the panel, it has been sufficient by using only one photographic device. However, in order to solve the detection error or dead detection region as discussed previously, one or more photographic devices can be added. The detection method may only concentrate on discerning the indication structure, the position of the panel, and the position of the indication structure on the panel. Here, the panel can also include a region serving as a virtual panel.

In the foregoing descriptions, all the designs of the setting pattern of the touching object, the light enhance mechanism, the identification information of the planar touching member, the border pattern associating with the photosensor design, the illumination direction of the light source, and the light source in alternative different wavelengths and the pen, can be designed in proper combination, according to the actual environment where is to be operated.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A touching panel apparatus with optical detection for location, comprising:
a touching panel;
at least a touching object;
a border at a periphery of the touching panel with a setting pattern;
at least two photographing units, located at two locations of the border, so as to photograph the touching object and the border on the touching panel; and
an analysis unit, used to receive and analyze a photographing data from the least two photographing units, and obtain a position of the touching object on the panel after analysis.

2. The touch panel apparatus of claim 1, wherein the setting pattern of the border includes one selected from the group consisting of a set of strips with the same color but different shade degree in alternating change, a set of alternating color strips, a set of strips parallel to the touch panel with different color, a set of strips parallel to the touch panel with same color different shade degree, and a single setting color.

3. The touch panel apparatus of claim 1, wherein the setting pattern of the border include a set of dense strips, which can also be used by the at least two photographic units to make a correction, and the correction comprises an angle correction.

4. The touch panel apparatus of claim 1, wherein the border includes a color light transparent material, so as to have a structure selected from the group consisting of a pattern with full a color light transparent region and a pattern composed of a color light transparent region and a light oblique region.

5. The touch panel apparatus of claim 4, wherein the light oblique region is a dark region and the color light transparent region is a bright region.

6. The touch panel apparatus of claim 1, wherein the border comprises at least one reflection region, so as to enhance the brightness of the setting pattern.

7. The touch panel apparatus of claim 1, wherein the photographic units includes a photosensing cell array, which comprises a plurality of photosensing lines, wherein the photosensing lines of the photosensing array are operated together to increase the detecting sensibility and precision for the touching object.

8. A touching panel apparatus with optical detection for location, comprising:
a touching panel;
at least a touching object;
a border at a periphery of the touching panel with a setting pattern, which has a structure for enhancing light intensity;
at least two photographing units, located at two locations of the border, so as to photograph the touching object and the border on the touching panel; and
an analysis unit, used to receive and analyze a photographing data from the least two photographing units, and obtain a position of the touching object on the panel after analysis.

9. The touch panel apparatus of claim 8, wherein the setting pattern of the border includes one selected from the group consisting of a set of strips with the same color but different shade degree in alternating change, a set of alternating color strips, a set of strips parallel to the touch panel with different color, a set of strips parallel to the touch panel with same color different shade degree, and a single setting color.

10. The touch panel apparatus of claim 8, wherein each one of the at least two photographic units comprises a photosensing cell array, wherein the photosensing cell array can includes a region, which has an optical gain different from that of the other region of the photosensing cell array.

11. The touch panel apparatus of claim 8, wherein the border includes a color light transparent material, so as to have a structure selected from the group consisting of a pattern with full a color light transparent region and a pattern composed of a color light transparent region and a light oblique region.

12. A touching panel apparatus with optical detection for location, comprising:
a touching panel;
a touching object, having a setting pattern structure with a light enhance structure;
a border optionally included and located at a periphery of the touching panel with a setting pattern;
at least one photographing units, located at a location of the touching panel, so as to photograph the touching object and the setting pattern of the optional border; and
an analysis unit, used to receive and analyze a photographing data from the least one photographing units, and obtain a position of the touching object on the panel after analysis.

13. The touch panel apparatus of claim 12, wherein the setting pattern structure of the touching object includes one selected from the group consisting of a set of strips with the same color but different shade degree in alternating change, a set of alternating color strips, a set of strips parallel to the touch panel with different color, a set of strips parallel to the touch panel with same color different shade degree, and a single setting color.

14. A touching panel apparatus with optical detection for location, suitable for use on a panel, so as to obtain a touching position on the panel, comprising:
at least one touching object;
at least one planar photographic unit, respectively implemented at a place of the apparatus, so as to photograph a detected plane by a slant angle, wherein the at least one planar photographic unit has multiple row lines and multiple column lines in crossing to form a coordinate plane for photographing at least one plane over the panel, and photograph the at least one touching object, and then export a first video information signal;
at least one planar light source to form an illuminating plane, which is close and substantially parallel to a surface of the panel, so as to illuminate the at least one touching object;
optionally including at least one line-type photographic unit, located at a place of the apparatus, wherein the line-type photographic unit photographs and detects a plane, which is close and substantially parallel to the panel, and the touching object, and exports a second video information signal; and
a signal analysis unit, receiving the first video information signal exported by the at least one planar photograph unit and optionally the second video information signal exported by the at least one line-type photograph unit, so as to obtain a panel position of the at least one touching object on the surface of the panel.

15. A location detection apparatus, suitable for use on a panel, so as to obtain a touching position on the panel, comprising:
at least one touching object;
at least one planar movable touching member, disposed on the panel;
at least one planar photographic unit, respectively implemented at a place of the apparatus with a height from the panel, wherein the at least one planar photographic unit has multiple row lines and multiple column lines in crossing to form a coordinate plane, so as to photograph at least one plane over the panel by a slant angle, and photograph the at least one touching object and the at least one planar movable touching member, and then export a first video information signal;
optionally including at least one line-type photographic unit, located at a place of the apparatus, wherein the line-type photographic unit photographs and detects a plane, which is close and substantially parallel to the panel and the touching object, and exports a second video information signal;
optionally including a light source to form an illuminating plane, which is close and substantially parallel to a surface of the panel, so as to illuminate the at least one touching object, wherein when the at least one touching object touches to the at least one planar movable touching member, the light source is reflected by the at least one touching object, so as to detect the least one touching object in auxiliary; and
a signal analysis unit, receiving the first video information signal exported by the at least one planar photograph unit so as to obtain a panel position of the at least one touching object on the surface of the panel, and a panel position of the at least one planar movable touching member on the panel,
wherein the signal analysis unit also can optionally receives the second video information signal exported by the at least one line-type photograph unit, so as to analyze the panel position of the at least one touching object on the surface of the panel in auxiliary.

16. The apparatus of claim 15, wherein while the signal analysis unit detects the panel position of the at least one touching object and the panel position of the at least one planar movable touching member on the panel, the at least one planar movable touching member includes a being-written object and the at least one touching object includes a writing object.

17. The apparatus of claim 15, wherein when the al least one touching object moves and touches the at least one planar movable touching member, the planar photographic unit and the line-type photographic unit simultaneously detect a relative position between the at least one planar movable touching member and the at least one touching object.

18. The apparatus of claim 15, wherein the at least one planar movable touching member includes a setting discerning indication in a direction, and can be discerned by the signal analysis unit according to a discerning information stored therein.

19. The apparatus of claim 16, wherein the setting discerning indication of the at least one planar movable touching member includes a square/rectangular shape.

20. A movable location detection apparatus, suitable for use on a panel, so as to obtain a touching position on the panel, the apparatus comprising:
a display screen;
at least one touching object; and
an optical location detection unit, which photograph a plane of the panel and the at least one touching object by a slant angle, wherein the plane has a touching detection region to form a virtual touching panel,
wherein the optical location detection unit can detect a (X,Y) coordinate on the virtual touching panel when the at least one touching object touch on the virtual touching panel, wherein the optical location detection unit also exports a signal to control the displayed pattern on the display screen to have a motion.

21. The apparatus of claim 20, wherein the virtual touching panel comprises one selected from the group consisting of (1) a region defined by a square/rectangular pattern projected on the panel, (2) a region in a direction defined by two indication marks projected on the panel, (3) a region defined, in a relative position, from a directional pattern projected on the panel.

22. The apparatus of claim 20, wherein the virtual touching panel comprises one selected from the group consisting of (1) a region defined from the apparatus in a relative position, (2) a region defined by a covering region by a movable directional object, (3) a region defined between the apparatus and a movable and directional marking object.

23. An optical location detecting apparatus, comprising:
a touching panel;
at least one touching object;
at least one photographic unit, to photograph the touching panel and the at least one touching object;
a control unit;
a light source, the light source optionally capable of illuminating different colors in alternative way, wherein an illumination direction of the light source deviated by an angle from the at least one photographic unit, so that the at least one photographic unit does not directly detect a reflected light of the light source from the touching panel, wherein when the at least one touching object intersects the light source, a reflection light by the light source is generated, and the at least one photographic unit can detect the reflection light and export a signal; and
a control unit, used to receive the signal exported by the at least one photographic unit an analyze out the touching point through discerning the reflection light,
wherein the apparatus optionally can take a background image information at an initial stage and store in the control unit for later use of comparison in analysis.

24. The apparatus of claim 23, wherein a location for the at least one photographic unit is to have a detection plane that is close and substantially parallel to the touching panel.

25. A location detection apparatus, suitable for use on a panel, comprising:
at least one touching object having a tip region, wherein the tip region is used to touch on the panel;
a light emitting unit, implemented on the tip region;
a touching button, implemented on the tip region, wherein the touching button can be switched on by touching, so as to activate the light emitting unit to emit an optical signal;
at least one photographic unit, respectively located at a place of the apparatus,
wherein at least one photographic unit photographs the panel by a slant angle,
wherein the at least one photographic unit has multiple row lines and multiple column lines in crossing to form a coordinate plane, so as to photograph at least one plane over the panel, and photograph the optical signal emitted by the at least one touching object, and then export a video information signal; and
a signal analysis unit, receiving the video information signal, so as to analyze out one point from the light emitting unit to determine the touching position of the at least one touching object on the panel.

26. The apparatus of claim 25, wherein in the signal analysis unit, the one point from the light emitting unit is a least point to the at least one photographic unit, so as to determine the touching position of the at least one touching object, wherein the least point is determined by a principle:
according to the analysis of the video information signal, when the touching object touches the panel, the light emitting unit has a plurality of detection points being detected, and the detection points have one detection point in video information with the least distance to the photographic unit is determined as the least point, and the position of the least point is the touching position or a reference position from the touching position.

27. A touching panel apparatus with optical detection for location, comprising:
a touching panel;
at least one touching object, capable of emitting different colors;
at least one photographing unit with a photosensing array to detect the different colors, wherein the at least one photographing unit is located at a location with respect to the touching panel, so as to at least photograph the touching object by a slant angle; and
an analysis unit, used to receive and analyze a photographing data output from the least one photographing unit, and obtain a position of the touching object on the panel after analysis, wherein the position is determined by a principle of most sensibility position, in which all of the different colors have been separately detected by the at least one photographing unit and the position is determined according to detecting results form each of the different colors by the principle of most sensibility position.
